(19) United States
(12) Patent Application Publication
(10) Pub. No.: US 2011/0169259 A1
(43) Pub. Date: Jul. 14, 2011

(54) TUBE FITTING CONNECTION

(75) Inventor: Jörg Schulze, Mainz (DE)

(73) Assignee: GM GLOBAL TECHNOLOGY OPERATIONS, INC., Detroit, MI (US)

(21) Appl. No.: 12/687,481

(22) Filed: Jan. 14, 2010

(51) Int. Cl. F16L 55/00

(52) U.S. Cl. 285/24

(57) ABSTRACT

A tube fitting assembly is provided that includes a tube having a laterally outwardly extending flange formed adjacent an end thereof and a nipple portion between the flange and the end of the tube. A sealing member is disposed on and circumscribes the nipple portion of the tube. A gland nut is provided that includes an opening therethrough to receive the tube. The gland nut is adapted to be releasably coupled to a coupling member. The coupling member includes a counter bore formed therein to receive the sealing member and the nipple portion of the tube, wherein the gland nut abuts the flange of the tube to substantially secure the sealing member and the nipple portion within the counter bore to form a substantially fluid tight seal between the tube and the coupling member.

### FIELD OF THE INVENTION

The present disclosure relates to a tube fitting connection and more particularly to a tube fitting connection for pressurized fluids.

### BACKGROUND OF THE INVENTION

It is common practice to employ tubing between a source of a fluid and an associated fluid receiving member remotely located from the source, wherein the tubing forms a conduit for the transfer of fluids therebetween. The tubing typically includes connectors associated with ends of the tubing to facilitate an attachment of the ends of the tubing to the source and to the associated fluid receiving member.

In certain applications, the fluid may be a high pressure fluid, wherein the tubing and the connectors are required to form and maintain a substantially fluid tight seal between the respective ends of the tubing and the source and the associated fluid receiving member. A number of tubing and connector assemblies have been employed to provide the substantially fluid tight connections. Various compression fitting and flange fitting assemblies have been employed that may include polymeric seals, threaded connectors, and quick-connect connectors, for example. Many of these assemblies include a number of cooperating parts that must be pre-assembled and subsequently attached to the tubing and to the source and the associated fluid receiving member. The numerous parts and pre-assembly of such tubing and connector assemblies increase a cost thereof, as well as the time necessary to either attach or detach the tubing to the source and the associated fluid receiving member. The increased time to attach the tubing and the connector assemblies increases a cost of initial assembly thereof and increases a cost associated with disassembly thereof when servicing any one of the tubing, the connectors, the source, and the associated fluid receiving member.

It is desirable to produce a cost effective tube fitting connection for interconnecting a source of a fluid and an associated fluid receiving member to form a conduit for the transfer of the fluid therebetween.

### SUMMARY OF THE INVENTION

Compatible and attuned with the present invention, a cost effective tube fitting connection for interconnecting a source of fluid and an associated fluid receiving member to form a conduit for the transfer of the fluid therebetween, has been surprisingly discovered.

In one embodiment, a tube fitting connector comprises a tube including a laterally outwardly extending flange formed adjacent an end thereof and a nipple portion between the flange and the end; a gland nut received on the tube adjacent the flange; a coupling member for releasably coupling with the gland nut, the coupling member including at least one counter bore formed therein to receive the nipple portion of the tube; and a sealing member disposed between the nipple portion of the tube and the coupling member, wherein the gland nut abuts the flange of the tube to substantially secure the sealing member and the nipple portion of the tube within the at least one counter bore to form a substantially fluid tight seal between the tube and the coupling member.

In another embodiment, a tube fitting connector comprises a tube including a laterally outwardly extending flange formed adjacent an end thereof and a nipple portion between the flange and the end; a gland nut received on the tube adjacent the flange; a coupling member for releasably coupling with the gland nut, the coupling member including a first counter bore formed therein to receive the nipple portion of the tube, a second counter bore formed in an end of the first counter bore to receive at least a portion of the nipple portion of the tube, and a through bore extending from an end of the second counter bore through the coupling member to form a fluid flow path therethrough; and a sealing member disposed between the nipple portion of the tube and the coupling member, wherein the flange of the tube is secured between the gland nut and the coupling member to form a substantially fluid tight seal between the tube and the coupling member.

In another embodiment, a tube fitting connector for transferring hydrogen between a source of hydrogen and a fuel cell comprises a tube including a laterally outwardly extending flange formed adjacent an end thereof and a nipple portion between the flange and the end; a gland nut formed from one of an aluminum and a stainless steel and including an opening therethrough to receive the tube; a coupling member for releasably coupling with the gland nut, the coupling member including at least one counter bore formed therein to receive the nipple portion of the tube; and an O-ring formed from one of a thermoplastic polyurethane (TPU) and a polyetherkeytone (PEK) disposed between the nipple portion of the tube and the coupling member, wherein the gland nut abuts the flange of the tube to substantially secure the sealing member and the nipple portion of the tube within the at least one counter bore to form a substantially fluid tight seal between the tube and the coupling member.

### DRAWINGS

The above, as well as other advantages of the present invention will become readily apparent to those skilled in the art from the following detailed description, particularly when considered in the light of the drawings described hereafter.

FIG. 1 is an exploded fragmentary perspective view of a tube fitting connection according to an embodiment of the invention;

FIG. 2 is a fragmentary cross-sectional elevational view of the tube fitting connection of FIG. 1 shown assembled;

FIG. 3 is an exploded fragmentary perspective view of a tube fitting connection according to another embodiment of the invention; and

FIG. 4 is a fragmentary cross-sectional elevational view of the tube fitting connection of FIG. 3 shown assembled.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features.

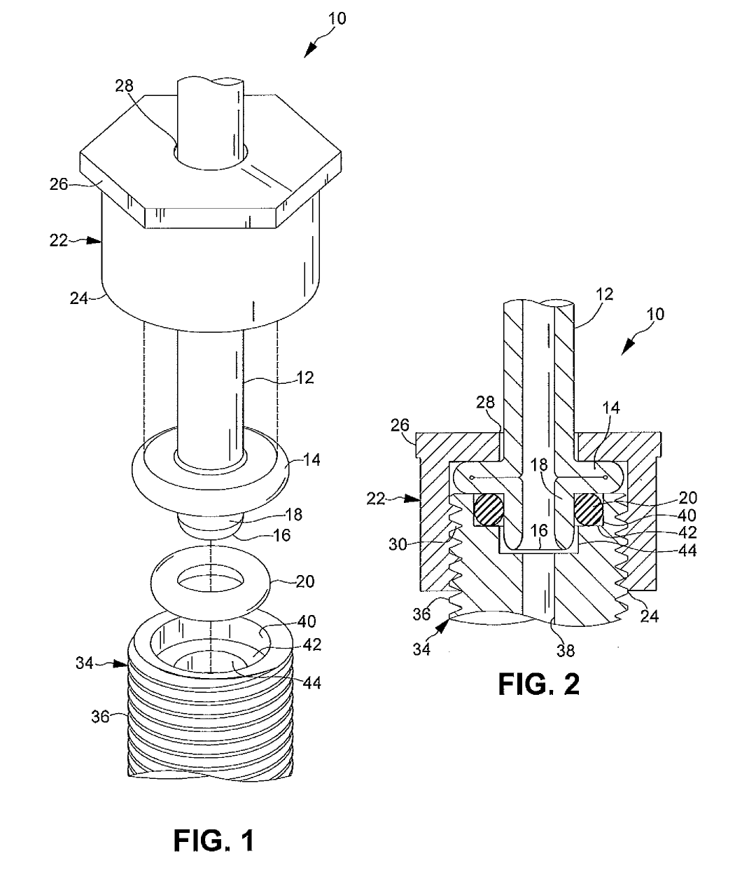

FIGS. 1-2 show a tube fitting connection 10 for a tube 12 according to an embodiment of the present disclosure. The tube fitting connection 10 includes a sealing member 20 and a gland nut 22 which cooperate with a male connector 34 to form a substantially fluid tight seal. The tube fitting connection 10 and the tube 12 form a conduit for the transfer of fluids between a source of a fluid (not shown) and an associated fluid receiving member (not shown) remotely located from the source.

The tube 12 includes a laterally outwardly extending flange 14 formed adjacent an end 16 of the tube 12. In the illustrated embodiment, the tube 12 is formed from a metallic material such as an aluminum, a copper, a brass, or a stainless steel, for example. It should be understood that other metals having suitable physical and chemical properties may be employed to form the tube 12. Additionally, it should be understood that non-metal materials such as a thermoplastic and a nylon, for example, or any other non-metal material having suitable physical and chemical properties may be employed to form the tube 12. Further, it should be understood that the tube 12 may be a flexible tube or a substantially rigid tube. As shown, an outside diameter of the tube 12 may selected wherein the outside diameter, an inside diameter, and a wall thickness cooperate to provide a desired stiffness to the tube 12 and a desired fluid flow volume through the tube 12.

A length of the tube 12 between the flange 14 and the end 16 forms a nipple 18. A sealing member 20 is disposed on the nipple 18, wherein the sealing member 20 circumscribes the nipple 18 and abuts the flange 14. It should be understood that a groove or other retaining member can be formed in an outer surface of the nipple 18 to facilitate retaining the nipple 18 thereon. In the illustrated embodiment, the sealing member 20 is an O-ring. It should be understood that other sealing members such as a flat washer, a square washer, and a packing rope, for example, may be employed for the sealing member 20. The sealing member 20 may be formed from a polymeric material such as a thermoplastic polyurethane (TPU) and a polyetherkeytone (PEK), for example, or any other material having suitable physical and chemical properties.

The gland nut 22 is a generally cylindrical sleeve having a first opening 24 at a first end. A lip 26 extends laterally outwardly from the gland nut 22 adjacent a second end. A generally circular shaped second opening 28 is formed at the second end of the gland nut 22. The first opening 24 is adapted to allow the flange 14 of the tube 12 to be received within the gland nut 22, with the nipple 18 extending toward the first opening 24. The second opening 28 is adapted to allow the tube 12 to pass therethrough, wherein the flange 14 abuts a wall forming the second opening 28. The gland nut 22 is free to rotate about a longitudinal axis of the tube 12. A thread 30 is formed on the inner surface of the gland nut 22 adjacent the first end to facilitate coupling the gland nut 22 to the male connector 34. It should be understood that the gland nut 22 can be formed to include other attachment means such as a snap-fit, a quick-connect, and the like, for example, to facilitate coupling the gland nut 22 to the male connector 34.

A peripheral edge of the lip 26 has a generally hexagonal shape. The hexagonal shape facilitates gripping the gland nut 22 with a tool or a hand, for example. It should be understood that other shapes and features can be provided such as a generally square shape or a pair of outwardly extending tabs, for example, to facilitate gripping the gland nut 22.

In the illustrated embodiment, the gland nut 22 is formed from a metallic material such as an aluminum, a copper, a brass, or a stainless steel, for example. It should be understood that other metals having suitable physical and chemical properties may be employed to form the gland nut 22. Further, it should be understood that non-metal materials such as a thermoplastic and a nylon, for example, or any other non-metal material having suitable physical and chemical properties may be employed to form the gland nut 22.

The male connector 34 is a generally cylindrical coupling member having a threaded portion 36 formed on an outer surface thereof. The threaded portion 36 is adapted to be received by the first opening 24 of the gland nut 22 and threadably engage the thread 30 thereof. It should be understood that the male connector 34 can be formed without the threaded portion 36 and include other attachment means such as a snap-fit, a quick-connect, and the like, for example, to facilitate coupling the male connector 34 to a similarly configured gland nut. A first counter bore 40 is formed in a first end of the male connector 34. A second counter bore 44 is formed in an end of the first counter bore 40. The second counter bore 44 has a diameter that is smaller in diameter than the first counter bore 40 and is substantially concentric with the first counter bore 40. The first counter bore 40 and the second counter bore 44 form a shoulder 42. The first counter bore 40 is adapted to receive the nipple 18 and the sealing member 20, wherein the sealing member 20 abuts the shoulder 42. The second counter bore 44 is adapted to receive at least a portion of the nipple 18 of the tube 12. A through bore 38 is formed in the male connector 34 that extends from an end of the second counter bore 44 through the male connector 34 to provide a fluid flow path therethrough. The through bore 38 has a diameter that is smaller than the diameter of the second counter bore 44 and is substantially concentric with the second counter bore 44. It should be understood that the through bore 38 and the second counter bore 44 can have substantially similar diameters, wherein the through bore 38 and the second counter bore 44 form a substantially continuous through bore.

In the illustrated embodiment, the male connector 34 is formed from a metallic material such as an aluminum, a copper, a brass, or a stainless steel, for example. It should be understood that other metals having suitable physical and chemical properties may be employed to form the male connector 34. Further, non-metal materials such as a thermoplastic and a nylon, for example, or any other non-metal material having suitable physical and chemical properties may be employed to form the male connector 34. It should be further understood that the male connector 34 may be integrally formed in an associated fluid supply tube, a fluid holding tank, an associated fluid receiving member, and the like, for example. Further, the male connector 34 may be a separate member adapted to be removably coupled to an associated fluid supply tube, a fluid holding tank, an associated fluid receiving fluid receiving member, and the like, for example. The male connector 34 may include a threaded end, a quick-connect end, a snap-fit end, or the like, for example, to facilitate removably coupling the male connector 34 to the associated fluid supply tube, the fluid holding tank, the associated fluid receiving member, and the like.

In use, the tube fitting connection 10 is employed to form a conduit for a transfer of fluids between a source of a fluid and an associated fluid receiving member remotely located from the source. The tube 12 is inserted through the second opening 28 of the gland nut 22 causing the first opening 24 thereof to face the end 16 of the tube 12. The tube 12 is deformed to form the flange 14 and the nipple 18 adjacent the end 16. The flange 14 causes the gland nut 22 to be retained on the tube 12. The sealing member 20 is removably received around the nipple 18 and positioned thereon to abut the flange 14.

The end 16 of the tube 12 is removable received by the male connector 34, wherein the nipple 18 is received in the second counter bore 44 and the sealing member 20 is received in the first counter bore 40. When the tube 12 is received by the male connector 34, the end 16 of the tube 12 is in substantial axial alignment with the through bore 38 of the male connector 34 to facilitate a flow of fluid therebetween. The gland nut 22 is caused to rotate in respect of the longitudinal axis of the male connector 24 to cause the thread 30 of the gland nut 22 to threadably engage the threaded portion 36 of the male connector 34. As the gland nut 22 is threadably received over the male connector 34, the gland nut 22 is caused to abut the flange 14 to retain the nipple 18 within the second counter bore 44 of the male connector 24 and the sealing member 20 in the first counter bore 40 of the male connector 24. Upon a further rotation of the gland nut 22 in respect of the male connector 34, an axial clamping force is developed between the gland nut 22 and the male connector 34. The clamping force substantially secures the end 16 of the tube 12 within the male connector 24 and causes the sealing member 20 to form a substantially fluid tight seal between the tube 12 and the male connector 34. It should be understood that a selected torque can be applied to the gland nut 22 to produce a desired clamping force.

The tube fitting connection 10 provides a substantially fluid tight seal between the tube 12 and the male connector 34. The axial clamping force between the gland nut 22 and the male connector 34 causes a deformation of the sealing member 20, which in-turn causes the sealing member 20 to sealingly engage the flange 14 and the nipple 18 of the tube 12 and the surfaces forming the first counter bore 40. The substantially fluid tight seal between the tube 12 and the male connector 34 may be maintained at high fluid pressures such as about 875 bar (12,690.8 psi) or higher, which are typical in applications where the fluid is a hydrogen being supplied to an associated fuel cell stack, for example.

The number of individual parts employed for the tube fitting connection 10 is minimized to thereby minimize a cost of the tube fitting connection 10 and a time associated with manufacturing, assembling, and installing the tube fitting connection 10. The minimized number of parts also minimizes a time necessary to either attach or detach the tubing to the source and the associated fluid receiving member. The minimized time to attach the tubing and connector assemblies minimizes a cost of assembly thereof. The minimized time to detach such tubing and connector assemblies minimizes a cost associated with disassembly thereof when servicing any one of the tubing, the connectors, the source, and the associated fluid receiving member.

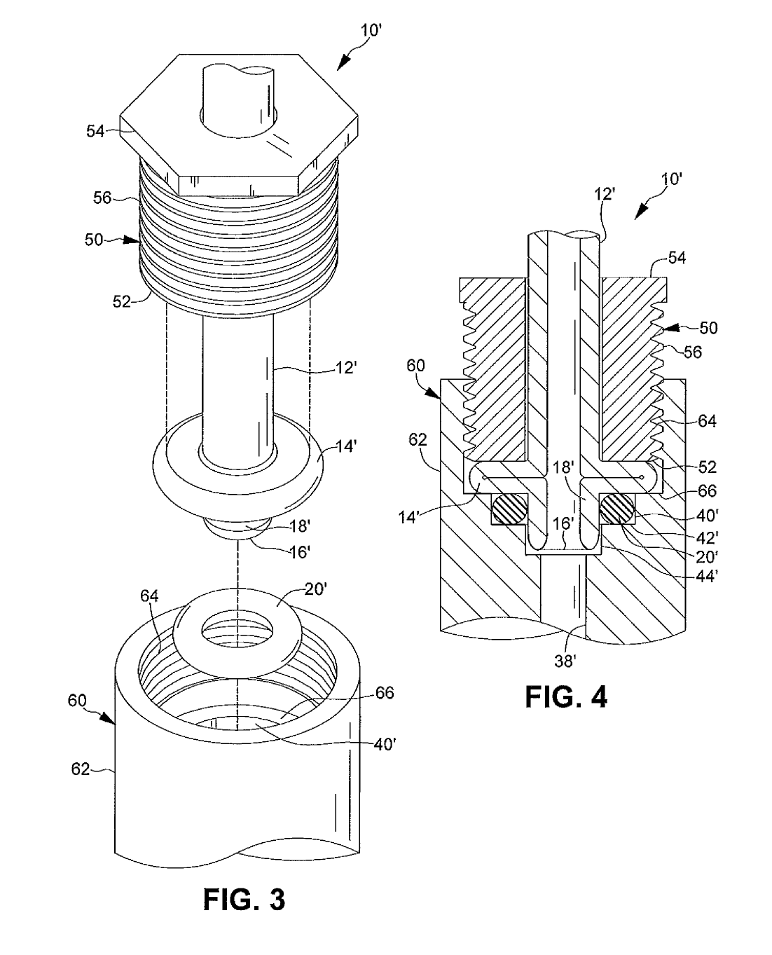

FIGS. 3-4 illustrate an alternate embodiment of the invention. Structure similar to that illustrated in FIGS. 1-2 includes the same reference numeral and a prime (′) symbol for clarity. In the embodiment shown, the tube fitting connection 10′ includes a gland nut 50 adapted to be received by a female connector 60. The gland nut 50 is generally cylindrical sleeve having a first end 52 and a second end 54. The gland nut 50 is adapted to slidably receive a tube 12′ therethrough. A thread 56 is formed on an outer surface of the gland nut 50 adjacent the first end 52 thereof to facilitate coupling the gland nut 50 to the female connector 60. It should be understood that the gland nut 50 can be formed to include other attachment means such as a snap-fit, a quick-connect, and the like, for example, to facilitate coupling the gland nut 50 to the female connector 60.

A peripheral edge of the second end 54 of the connector 60 has a generally hexagonal shape. The hexagonal shape facilitates gripping the gland nut 50 with a tool or a hand, for example. It should be understood that other shapes and features can be provided such as a generally square shape or a pair of outwardly extending tabs, for example, to facilitate gripping the gland nut 50. In the illustrated embodiment the gland nut 50 is formed from a metallic material such as an aluminum, a copper, a brass, or a stainless steel, for example. It should be understood that other metals having suitable physical and chemical properties may be employed to form the gland nut 50. Further, it should be understood that non-metal materials such as a thermoplastic and a nylon, for example, or any other non-metal material having suitable physical and chemical properties may be employed to form the gland nut 50.

The female connector 60 includes a main body 62 having a threaded bore 64 formed therein. The threaded bore 64 is adapted to threadably receive the thread 56 of the gland nut 50. It should be understood that the female connector 60 can be formed without the threaded bore 64 and include a bore formed therein having other attachment means such as a snap-fit, a quick-connect, and the like, for example, to facilitate coupling the female connector 60 to a similarly configured gland nut. Additionally, the threaded bore 64 is adapted to receive the flange 14′ of the tube 12′, wherein at least a portion of the flange 14′ abuts a bottom surface 66 of the threaded bore 64. A first counter bore 40′ is formed in the bottom surface 66 of the threaded bore 64. The first counter bore 40′ has a diameter that is smaller than the diameter of the threaded bore 64 and is substantially concentric with the threaded bore 64. A second counter bore 44′ is formed in a bottom surface of the first counter bore 40′. The second counter bore 44′ has a diameter that is smaller than the diameter of the first counter bore 40′ and is substantially concentric with the first counter bore 40′. The first counter bore 40′ and the second counter bore 44′ form a shoulder 42′. The first counter bore 40′ is adapted to receive the nipple 18′ and the sealing member 20′, wherein the sealing member abuts the shoulder 42′. The second counter bore 44′ is adapted to receive at least a portion of the nipple 18′ of the tube 12′. A through bore 38′ is formed in the female connector 60 that extends from a bottom surface of the second counter bore 44′ through the female connector 60 to provide a fluid flow path therethrough. The through bore 38′ has a diameter that is smaller than the diameter of the second counter bore 44′ and is substantially concentric with the second counter bore 44′. It should be understood that the through bore 38′ and the second counter bore 44′ can have substantially similar diameters, wherein the second counter bore 44′ and the through bore 38′ form a substantially continuous through bore.

In the illustrated embodiment, the female connector 60 is formed from a metallic material such as an aluminum, a copper, a brass, or a stainless steel, for example. It should be understood that other metals having suitable physical and chemical properties may be employed to form the female connector 60. Further, non-metal materials such as a thermoplastic and a nylon, for example, or any other non-metal material having suitable physical and chemical properties may be employed to form the female connector 60. It should be further understood that the female connector 60 may be integrally formed in an associated fluid supply tube, a fluid holding tank, an associated fluid receiving member, and the like, for example. Further, the female connector 60 may be a separate member adapted to be removably coupled to an associated fluid supply tube, a fluid holding tank, an associated fluid receiving member, and the like, for example. The female connector 60 may include a threaded end, a quick-connect end, a snap-fit end, or the like, for example, to facilitate removably coupling the female connector 60 to the associated fluid supply tube, the fluid holding tank, the associated fluid receiving member, and the like.

In use, the end 16′ of the tube 12′ is removable received by the female connector 60, wherein the nipple 18′ is received in the second counter bore 44′ and the sealing member 20′ is received in the first counter bore 40′. When the tube 12′ is received by the female connector 60, the end 16′ of the tube 12′ is in substantial axial alignment with the through bore 38′ of the female connector 60 to facilitate a flow of fluid therebetween. The first end of the gland nut 50 is received within the female connector 60 and caused to rotate in respect thereof to cause the thread 30′ of the gland nut 50 to threadably engage the threaded bore 64 of the female connector 60. As the gland nut 50 is threadably received in the threaded bore 64 of the female connector 60, the first end 52 of the gland nut 50 is caused to abut the flange 14′ to retain the nipple 18′ within the second counter bore 44′ of the female connector 60 and to retain the sealing member 20′ in the first counter bore 40′ of the female connector 60. Upon a further rotation of the gland nut 50 in respect of the female connector 60, an axial clamping force is developed between the gland nut 50 and the female connector 60. The clamping force substantially secures the end 16′ of the tube 12′ within the female connector 60 and causes the sealing member 20′ to form a substantially fluid tight seal between the tube 12′ and the female connector 34′. It should be understood that a selected torque can be applied to the gland nut 50 to produce a desired clamping force. The remaining structure and function of the embodiment illustrated in FIGS. 2-3 is substantially equivalent to the function and structure of the embodiment illustrated in FIG. 1 previously described herein.

In the illustrated embodiments, when the tube 12, 12′ is formed from a deformable material such as a metallic material, for example, the flanges 14, 14′ may be formed employing a bulge forming process, wherein a radial force is applied to an inner surface of the tubes 12, 12′ to cause a portion of the tubes 12, 12′ to expand outwardly and fold upon themselves to form the generally annular shaped laterally extending flanges 14, 14′. The bulge forming process provides a low cost method of forming the flanges 14, 14′, wherein necessary secondary manufacturing operations to complete the manufacture of the tube fitting connections 10, 10′ such as welding or machining, for example, are minimized.

In the illustrated embodiments, only the one end 16, 16′ of the tubes 12, 12′ is shown. It should be understood that the flanges 14, 14′ may be formed in an opposite end (not shown) of the tubes 12, 12′ to provide the tube fitting connections 10, 10′ for both ends of the tubes 12, 12′.

It should be understood that the tube fitting connector 10, 10′ can include a pressure release feature to facilitate a release of the fluid from the tube fitting connector 10, 10′ in the event the fluid escapes from the fluid flow path therethrough. The pressure release feature can be formed in the gland nuts 22, 50, the male connector 34, and the female connector 60. For example, a pressure release bore as is known in the art can be formed in an interior surface of the gland nut 22 shown in FIG. 2 and the female connector 60 shown in FIG. 4 adjacent the flanges 14, 14′, respectively.

While certain representative embodiments and details have been shown for purposes of illustrating the invention, it will be apparent to those skilled in the art that various changes may be made without departing from the scope of the disclosure, which is further described in the following appended claims.

What is claimed is:

1. A tube fitting connector comprising:
a tube including a laterally outwardly extending flange formed adjacent an end thereof and a nipple portion between the flange and the end;
a gland nut received on the tube adjacent the flange;
a coupling member for releasably coupling with the gland nut, the coupling member including at least one counter bore formed therein to receive the nipple portion of the tube; and
a sealing member disposed between the nipple portion of the tube and the coupling member, wherein the gland nut abuts the flange of the tube to substantially secure the sealing member and the nipple portion of the tube within the at least one counter bore to form a substantially fluid tight seal between the tube and the coupling member.

2. The tube fitting connector according to claim 1, wherein the tube is formed from one of a metallic and a polymeric material.

3. The tube fitting connector according to claim 1, wherein the sealing member is an O-ring.

4. The tube fitting connector according to claim 1, wherein the sealing member is formed from a polymeric material.

5. The tube fitting connector according to claim 1, wherein the sealing member is formed from one of a thermoplastic polyurethane (TPU) and a polyetherkeytone (PEK).

6. The tube fitting connector according to claim 1, wherein the gland nut includes a thread formed on an inner surface thereof and the coupling member includes a threaded portion formed on an outer surface thereof, wherein the gland nut is threadably received over the coupling member to substantially secure the flange of the tube between the gland nut and the coupling member.

7. The tube fitting connector according to claim 6, wherein the flange of the tube is received within the gland nut.

8. The tube fitting connector according to claim 1, wherein the gland nut includes a thread formed on an outer surface thereof and the coupling member includes a threaded bore formed therein, wherein the gland nut is threadably received within the threaded bore of the coupling member to substantially secure the flange of the tube between the gland nut and the coupling member.

9. The tube fitting connector according to claim 8, wherein the flange of the tube is received within the threaded bore of the coupling member.

10. The tube fitting connector according to claim 1, wherein at least one of the gland nut and the coupling member is formed from one of a metallic material and a polymeric material.

11. The tube fitting connector according to claim 1, wherein at least one of the gland nut and the coupling member is formed from one of an aluminum and a stainless steel.

12. A tube fitting connector comprising:
a tube including a laterally outwardly extending flange formed adjacent an end thereof and a nipple portion between the flange and the end;
a gland nut received on the tube adjacent the flange;
a coupling member for releasably coupling with the gland nut, the coupling member including a first counter bore formed therein to receive the nipple portion of the tube, a second counter bore formed in an end of the first counter bore to receive at least a portion of the nipple portion of the tube, and a through bore extending from an end of the second counter bore through the coupling member to form a fluid flow path therethrough; and
a sealing member disposed between the nipple portion of the tube and the coupling member, wherein the flange of the tube is secured between the gland nut and the coupling member to form a substantially fluid tight seal between the tube and the coupling member.

13. The tube fitting connector according to claim 12, wherein the sealing member is an O-ring formed from one of a thermoplastic polyurethane (TPU) and a polyetherkeytone (PEK).

14. The tube fitting connector according to claim 12, wherein at least one of the gland nut and the coupling member is formed from one of an aluminum and a stainless steel.

15. The tube fitting connector according to claim 12, wherein the gland nut includes a thread formed on an inner surface thereof and the coupling member includes a threaded portion formed on an outer surface thereof, wherein the flange of the tube is received within the gland nut and the gland nut is threadably received over the coupling member to substantially secure the flange of the tube between the gland nut and the coupling member.

16. The tube fitting connector according to claim 12, wherein the gland nut includes a thread formed on an outer surface thereof and the coupling member includes a threaded bore formed therein, wherein the flange of the tube is received within the threaded bore of the coupling member and the gland nut is threadably received within the threaded bore of the coupling member to substantially secure the flange of the tube between the gland nut and the coupling member.

17. A tube fitting connector for transferring hydrogen between a source of hydrogen and a fuel cell comprising:
a tube including a laterally outwardly extending flange formed adjacent an end thereof and a nipple portion between the flange and the end;
a gland nut formed from one of an aluminum and a stainless steel and including an opening therethrough to receive the tube;
a coupling member for releasably coupling with the gland nut, the coupling member including at least one counter bore formed therein to receive the nipple portion of the tube; and
an O-ring formed from one of a thermoplastic polyurethane (TPU) and a polyetherkeytone (PEK) disposed between the nipple portion of the tube and the coupling member, wherein the gland nut abuts the flange of the tube to substantially secure the sealing member and the nipple portion of the tube within the at least one counter bore to form a substantially fluid tight seal between the tube and the coupling member.

18. The tube fitting connector according to claim 17, wherein the gland nut includes a thread formed on an inner surface thereof and the coupling member includes a threaded portion formed on an outer surface thereof, wherein the flange of the tube is received within the gland nut and the gland nut is threadably received over the coupling member to substantially secure the flange of the tube between the gland nut and the coupling member.

19. The tube fitting connector according to claim 17, wherein the gland nut includes a thread formed on an outer surface thereof and the coupling member includes a threaded bore formed therein, wherein the flange of the tube is received within the threaded bore of the coupling member and the gland nut is threadably received within the threaded bore of the coupling member to substantially secure the flange of the tube between the gland nut and the coupling member.

20. The tube fitting connector according to claim 17, wherein the flange of the tube is a portion of the tube radially expanded outwardly and folded upon itself to form a generally annular shaped flange.
